(19) United States
(12) Patent Application Publication
(10) Pub. No.: US 2010/0094461 A1
(43) Pub. Date: Apr. 15, 2010

(54) METHOD FOR TEACHING AN INDUSTRIAL ROBOT, AND A CORRESPONDINGLY EQUIPPED INDUSTRIAL ROBOT

(75) Inventors: Michael ROTH, Wien (AT); Martin KOHLMAIER, Bad Voelsau (AT); Rainer KRAPPINGER, Stollhof (AT)

Correspondence Address: BUCHANAN, INGERSOLL & ROONEY PC, POST OFFICE BOX 1404, ALEXANDRIA, VA, 22313-1404, US

(73) Assignee: ABB AG, Wien (AT)

(21) Appl. No.: 12/576,741

(22) Filed: Oct. 9, 2009

(30) Foreign Application Priority Data
Oct. 10, 2008 (DE) 10 2008 050 930.2
Dec. 19, 2008 (DE) 10 2008 063 680.0

(51) Int. Cl. B25J 13/08; B25J 17/00; B25J 19/02

(52) U.S. Cl. 700/251; 74/490.05; 74/490.02

(57) ABSTRACT

A method is provided for teaching movement processes for an industrial robot having a stand and at least one moving jointed arm. The method includes fitting a measurement system to a measurement head at a free end of the jointed arm, fitting a handling appliance to an end effector at the free end of the jointed arm, operating the handling appliance to teach the intended movement process to the robot, detecting each position of the handling appliance, via the measurement head, transforming the detected positions to co-ordinate data and transmitting the detected co-ordinate data to a monitoring and control system, storing and evaluating the co-ordinate data in the monitoring and control system to develop a movement program for the robot. A correspondingly equipped industrial robot is also provided.

### RELATED APPLICATIONS

This application claims priority under 35 U.S.C. §119 to German Patent Application No. 10 2008 050 930.2 filed in Germany on Oct. 10, 2008, and to German Patent Application No. 10 2008 063 680.0 filed in Germany on Dec. 19, 2008. The entire contents of these applications are hereby incorporated by reference in their entireties.

### FIELD

The present disclosure relates to a method and apparatus for teaching movement processes for an industrial robot having a stand and at least one moving jointed arm.

### BACKGROUND INFORMATION

A controller or other similar device is used by an operator to move an industrial robot. The movement of the robot, for example, from one position to another or along a defined path, can be initiated by means of a joystick, which can be provided on the controller, or a command produced by means of a keyboard, such that the robot follows movement commands corresponding to the controlled variables of the keyboard and/or joystick. The connection between the controller and the control system can be permanent, and is not disconnected.

A path is defined to move the robot or its jointed arm from one position to another. The teaching of a position, such as picking up a tool, for example, involves a delicate sensitivity from the programmer, so as not to lead to damage to the components of the robot.

However, the programming of complex movement paths of a robot by means of a keyboard or joystick may sometimes be highly time-consuming, since each path point must be defined individually, and the corresponding movement by means of the joystick must be carried out carefully and precisely to avoid any faults in the movement path, or damage in the event of discrepancies.

### SUMMARY

An exemplary embodiment of the present disclosure provides a method of teaching movement processes for an industrial robot having a stand and at least one moving jointed arm. The exemplary method can comprise fitting a measurement system to a measurement head of the jointed arm at a free end of the jointed arm, and fitting a handling appliance to an end effector at the free end of the jointed arm, where the end effector is connectable to the measurement system. The exemplary method can also comprise operating the handling appliance to teach an intended movement process to the robot, and detecting each movement position of the handling appliance arranged at the free end of the jointed arm, via the measurement system fitted to the measurement head. In addition, the exemplary method can comprise transforming each detected position to respective co-ordinate data, transmitting the detected co-ordinate data to a monitoring and control system, and storing the transmitted co-ordinate data in the monitoring and control system. Furthermore, the exemplary method can comprise evaluating the stored co-ordinate data in the monitoring and control system, and storing the evaluated data as a movement program for the robot.

An exemplary embodiment provides an industrial robot. The exemplary industrial robot can comprise a stand, and at least one moving jointed arm. The jointed arm can have a free end comprising a detachable connection means for connecting and disconnecting an end effector to/from the free end of the jointed arm. The exemplary industrial robot can also comprise a measurement system having a measurement head arranged at the free end of the industrial robot. The measurement system can be configured to automatically determine each respective position and orientation of the end effector and transmit data representative of the determined position and orientation of the end effector to a monitoring and control unit. In addition, the exemplary industrial robot can comprise a handling appliance configured to teach movement processes for the robot and for the jointed arm, and to be guided manually.

### BRIEF DESCRIPTION OF THE DRAWINGS

Additional features, refinements, improvements, and advantages of the present disclosure will be explained in more detail below with reference to exemplary embodiments illustrated in the accompanying drawings, in which:

FIG. 1 shows a side perspective view of a known industrial robot;

FIG. 2 shows a side perspective view of an exemplary measurement head, which is arranged at a free end of a jointed arm of an industrial robot, according to at least one embodiment of the present disclosure;

FIG. 3 shows an exemplary housing with a measurement system arranged therein, for fitting to a free end of a jointed arm of an industrial robot; and

FIG. 4 shows an oblique view of an exemplary measurement head arranged at a free end of a jointed arm of an industrial robot, with a handling appliance attached to it, according to at least one embodiment of the present disclosure.

### DETAILED DESCRIPTION

Exemplary embodiments of the present invention provide a method and apparatus for teaching movement processes for an industrial robot having a stand and at least one moving jointed arm, in a simple, efficient and effective manner.

An exemplary embodiment of the present disclosure provides a process of teaching a robot manually (e.g., via control by an operator), in which the robot is guided by hand and each reached path point is stored electronically, to obtain a movement path from path co-ordinate data items after completion of the teaching process. According to an exemplary embodiment, the present disclosure provides a method of teaching movement processes for an industrial robot, in which the method can include, for example:
a) fitting a measurement system to a measurement head at a free end of the jointed arm of the robot;
b) fitting a handling appliance to an end effector at the free end of the jointed arm, in which the end effector is connectable to the measurement system;
c) operating the handling appliance (e.g., manually operating) by an operator to teach the intended movement process to the robot;
d) detecting each movement position of the handling appliance, which is arranged at the free end of the jointed arm, by means of the measurement system with the measurement head;
e) transforming each detected position to co-ordinate data, respectively;
f) transmitting the detected co-ordinate data to a monitoring and control system;
g) storing the transmitted co-ordinate data in the monitoring and control system;
h) evaluating the stored co-ordinate data by the monitoring and control system, and
i) storing the evaluated data as a movement program or as point cloud for the robot.

It is to be understood that the above-described storing operations can be implemented, for example, by writing data to a computer-readable recording medium, such as a non-volatile and/or volatile recording medium (e.g., hard disk drive, flash drive, internal writable memory, etc.).

According to an exemplary embodiment, the above-described operations a) to i) can include the following considerations. For example, regarding operation a), to define the respective physical position of the robot and of its end effector, and to detect the associated co-ordinates, it should be taken into consideration that a measurement system can be provided which detects this co-ordinate data and provides it for evaluation. Alternatively or in addition, the kinematics of the robot can be used as a measurement system. Regarding operation b), and handle can be provided as a handling appliance to handle the end effector, i.e., the free end of the jointed arm of the robot. According to an exemplary embodiment, the handle can permit precise manual guidance, and commands can also be transmitted to the robot control system. Regarding operation c), the movement of the handling appliance by the operator (e.g., person) carrying out the teaching should be taken into consideration. According to an exemplary embodiment, with reference to operation d), and particularly with regard to the precision of the robot movement processes to be set, the co-ordinates of each position can be detected (e.g., exactly) by means of the measurement head which can be mounted at the free end of the jointed arm of the robot. Alternatively, a tool center point can also be detected, such as the tool working point of the end effector; by the industrial robot control system itself. According to an exemplary embodiment, with regard to operation e), the detected co-ordinates of the respective position can be transformed to co-ordinate data which can be processed electronically and from which the movement path can later be derived. The robot control system can also enable this operation. Regarding operation f), the specific co-ordinate data can be transmitted, for example, from the robot to a monitoring and control system for evaluation purposes, according to an exemplary configuration. Regarding operation g), the respective co-ordinate data can be stored in the monitoring and control system, for subsequent processing thereof. Regarding operation h), the path co-ordinates can be evaluated either when they are stored, that is to say effectively synchronously (“real time”) or after their detection has been completed. With regard to operation i), the individual path co-ordinate data items can be combined to form a movement path as a movement program. The foregoing additional aspects are to be understood as exemplary implementations, and the present disclosure is not limited thereto.

According to an exemplary embodiment, a method is provided for teaching movement processes for an industrial robot. The exemplary method can be considered to be a combined manual and electronic method, since the relevant data is first of all generated manually, such as by manual movement of the handling appliance, for example, and measured data is electronically processed in real time (i.e., contemporaneously) or at a later time, and is stored as a movement program for controlling the robot.

According to an exemplary embodiment of the method, it is possible to first of all store the co-ordinate data, which has been detected and transformed by the measurement system, in the measurement system prior to transmitting the co-ordinate data to a monitoring and control system. For example, the co-ordinate data can be stored in a non-volatile computer-readable recording medium of the measurement system. Then, the co-ordinate data can be read and transmitted to the monitoring and control system, where the co-ordinate data is evaluated and stored as a movement program for controlling the robot.

According to another exemplary embodiment of the method, some or all of the co-ordinate data items detected by the measurement system can be transmitted directly to an external memory (e.g., non-volatile recording medium), such as in the monitoring and control system, for example, where these data items are pre-processed, for example by transformation, evaluation and compiling.

According to an exemplary embodiment of the method, the measurement variables detected by the measurement system can be transmitted in a protected form (e.g., encryption, cryptography, tunnelling, etc.). This protected transmission form can prevent corruption of the respective measured value.

According to an exemplary embodiment, individual positions of the handling appliance or the co-ordinate data of complete paths can be optionally detected.

According to an exemplary embodiment, the teaching of the robot can be carried out by means of so-called two-handed control. In this case, the co-ordinate data can be detected in six dimensions. Co-ordinate data can be detected in six dimensions for robots. Two-handed control makes it possible to carry out a co-ordinated movement in six dimensions, so that the application of moments to the measurement system is rendered simpler and more co-ordinated.

According to an exemplary embodiment, the detected and evaluated co-ordinate data can be used by the programmer to convert the movement path to an exact movement programme for path reproduction, for example.

In general, at least two different movement forms, such as linear and axial movement, for example, can be implemented for the handling appliance to define the movement of a robot between two points.

The exemplary method and additional exemplary implementations thereof as described herein offer the user a simple capability for programmed path control of the robot while simultaneously saving time and with precise implementation.

An exemplary embodiment of the present disclosure also provides an industrial robot that has a stand and at least one moving jointed arm whose free end is can be provided with connected means for a detachable connection between an end effector, such as a tool or of some other appliance, for example, and the free end of the jointed arm. This exemplary arrangement provides a capability to allow the movement processes of the robot to be determined easily.

An exemplary embodiment provides that a measurement system having a measurement head is arranged at a free end of the industrial robot. The measurement system automatically determines the respective position and orientation of the measurement head and transmits this to a monitoring and control unit, which can be external to or integral with a component of the robot. A handling appliance can also be arranged on the robot, such as on the free end of the joined arm, to teach movement processes for the robot and for the jointed arm, respectively. The handling appliance can be guided manually by an operator (e.g., a person) intended for this purpose.

According to an exemplary embodiment of the industrial robot in accordance with the present disclosure, the measurement system can be arranged in a protected manner in a housing at the free end of the jointed arm, such that the measurement system can be inserted and removed again at any time.

For this purpose, the measurement system can be accommodated in a rigid housing and communicate with the monitoring and control system via transmission lines which are arranged in a protected manner in the jointed arm of the robot.

Additional systems for a handling appliance, which are used in addition to the electronic controller, may be referred to as a “teaching appliance” hereinafter. These teaching appliances can be connected to the system handling appliance. Accordingly, both the mechanical system and the control system are firmly connected to one another and their removal involves a relatively long time. This arrangement can also apply to measurement systems which are fitted, for example, between the handling joint of a handling appliance and an end effector.

In known devices, the end effector is mechanically disconnected from the industrial robot to remove the components of the measurement system, which means that the end effector can be placed down. This makes manual teaching more difficult or virtually impossible.

An advantageous aspect of the present disclosure provides that a plug and/or latching connection can be included as the connection of the measurement system to the jointed arm. This plug and/or latching connection can allow or facilitate the measurement system to be fitted and removed easily, preferably without any tools, which offers a significant advantage over the known robot arrangement.

According to an exemplary embodiment of the industrial robot in accordance with the present disclosure, the measurement system, which is arranged at the free end of the jointed arm, can be removed without having to previously remove the end effector.

By way of example, a measurement system such as this may be a force measurement system for measurement of masses picked up and/or forces acting, for example a gripper, or other devices for the measurement of the angular position of the jointed arm or its orientation. In addition, a measurement system such as this offers the capability for calibration, to allow, for example, only the additional forces to be measured.

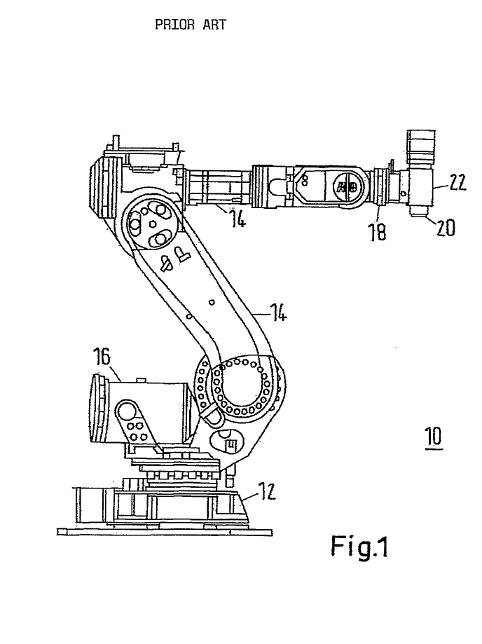

FIG. 1 shows a side perspective view of a known industrial robot 10. The industrial robot 10 has a stand 12 with a jointed arm 14 articulated thereon, and a drive 16.

A flange 18 is provided at a free end of the jointed arm 14. Various tools can be connected to the flange 18.

As shown in FIG. 1, a measurement head 22 for the manual teaching process is inserted between the flange 18 and an end effector 20, to constitute and/or accommodate any given tool to be operated by the robot 10. However, in accordance with the known robot 10, the measurement head 22 must be removed after the robot teaching process has been carried out and before the robot 10 can be used again correctly. This can involve a considerable amount of effort, in terms of time and fitting accuracy, for example.

Exemplary embodiments of the present disclosure provide a technical solution which avoids the aspect of removing the end effector 20 from the industrial robot 10 at a particular time to allow the measurement system 22, which is arranged and fitted in between the hand flange 18 of the robot 10 and the end effector 20, to be removed at any desired time. Until now, attempts to solve this problem have been unsatisfactory.

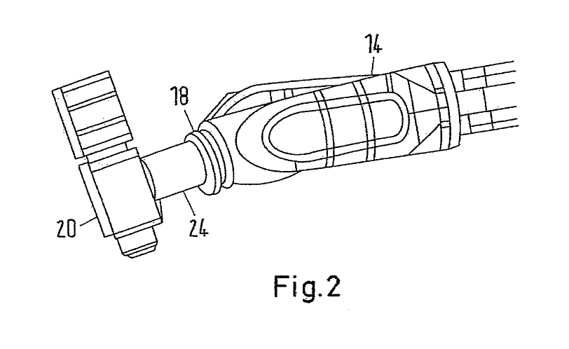

FIG. 2 shows a side perspective view of an exemplary measurement head (measurement system). A cylindrical housing 24, to which the end effector 20 is in turn connected, is accordingly flange-connected to the flange 18, which forms the termination of the jointed arm 14.

According to an exemplary embodiment, the robot comprises a housing which permits the measurement system 22 for teaching to be positioned during the teaching process, and also permits the measurement system to be removed with little effort before the start of any subsequent intended task. This measurement system 22, which can be positioned in the robot arm 14 only when desired, simplifies the fitting or removal of the measurement system 22 and likewise reduces the amount of time and effort involved, in comparison to that in the known robot 10 illustrated in FIG. 1.

The measurement system 22 is fitted in a rigid housing 24, in which the transmission of the respective measurement variables being ensured by an internal design. This arrangement makes it possible to release the measurement system 22 from the connection to the flange 18 by only a few actions, without having to remove the end effector 20 as in the known robot 10 illustrated in FIG. 1.

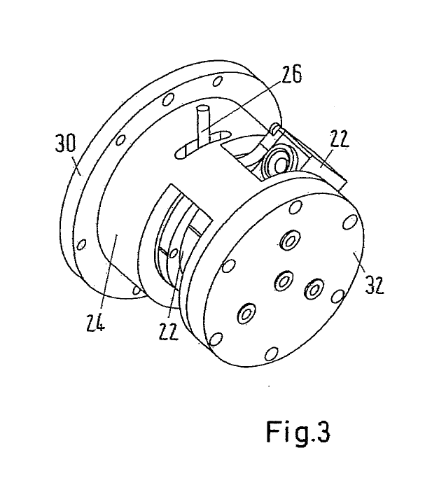

FIG. 3 shows an oblique view of the housing 24 in which the measurement system 22 can be temporarily arranged, such as for the duration of the teaching process, for example. However, the measurement system 22 can also remain on the robot after the teaching process, in order to allow force control for a process, for example. The housing 24 is cylindrical and has two end faces. One end face of the housing 24 includes a flange 30 that is configured to fit to (e.g., connect to) the flange 18 on a free end of the jointed arm 14 of the industrial robot 10. The other end face of the housing 24 is provided with a flange 32, which is configured to be connected to the end effector 20.

According to an exemplary embodiment of the disclosure, the process of positioning the measurement system 22 in the correct position in the housing 24 is simplified in that the measurement system 22 is secured by means of a latching device in the interior of the housing 24, for the entire time during which the measurement system 22 is accommodated in the housing 24. For example, a pivoting or actuating lever 26, which can be manually operated from outside of the housing 24, can be used to operate the latching device, and the measurement system 22. According to an exemplary arrangement, the pivoting or actuating lever 26 is provided to block or release the measurement system 22 in its installed position, depending on the position of the measurement system 22. Alternatively, the positioning of the measurement system 22 can be ensured, for example, by means of springs which are blocked after positioning, in order to ensure a rigid connection.

A plug connection may, of course, also be provided, by means of which the measurement system 22 can be positioned in the housing 24 and secured or released by means of the actuating or pivoting lever 26.

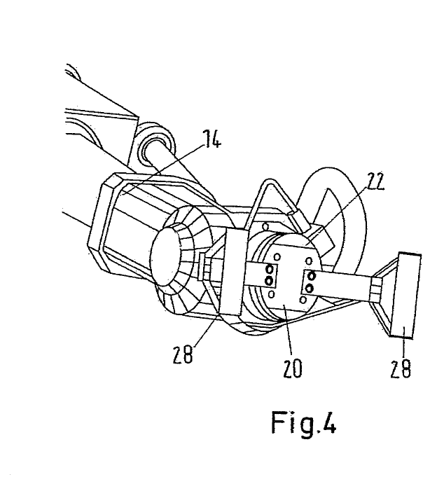

FIG. 4 shows an oblique view of the free end of a jointed arm 14 of a robot 10 which is equipped in a manner according to an exemplary embodiment of the present disclosure. Holding handles 28 are attached to the end effector 20 and are arranged diametrically opposite one another on both sides of the end effector 20. This arrangement allows manual guidance of the end effector 20 from both sides, and thereby makes it possible to carry out manual teaching in a simple manner.

The measurement head of the measurement system 22 can be seen behind the arrangement of the end effector 20 and holding handles 28. According to an exemplary embodiment, the measurement head of the measurement system 22 can be accommodated, for the teaching process, in the housing 24 (see FIGS. 2 and 3).

Furthermore, a monitoring and control system can be provided to carry out the method according to any of the above-described exemplary embodiments of the present disclosure. The monitoring and control system, can be selectively associated with the relevant robot 10, provided for each of a plurality of robots 10, or provided for at least a group (e.g., two or more) of robots 10, and control the robot(s) 10 with which the monitor and control system is associated and/or provided.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

10 Industrial robot
12 Stand
14 Jointed arm
16 Drive
18 Flange
20 End effector
22 Measurement system
24 Housing (for measurement system)
26 Actuating lever
28 Holding handle
30 Flange (for the robot)
32 Flange (for the end effector)

What is claimed is:

1. A method for teaching movement processes for an industrial robot having a stand and at least one moving jointed arm, comprising:
fitting a measurement system to a measurement head of the jointed arm at a free end of the jointed arm;
fitting a handling appliance to an end effector at the free end of the jointed arm, the end effector being connectable to the measurement system;
operating the handling appliance to teach an intended movement process to the robot;
detecting each movement position of the handling appliance arranged at the free end of the jointed arm, via the measurement system fitted to the measurement head;
transforming each detected position to respective co-ordinate data;
transmitting the detected co-ordinate data to a monitoring and control system;
storing the transmitted co-ordinate data in the monitoring and control system;
evaluating the stored co-ordinate data in the monitoring and control system; and
storing the evaluated data as a movement program for the robot.

2. The method for teaching movement processes for an industrial robot according to claim 1, comprising storing the co-ordinate data measured and transformed by the measurement system in a memory of the measurement system, prior to transmitting the co-ordinate data to the monitoring and control system, and reading and transmitting the co-ordinate data stored in the measurement system to the control system for evaluation and recordation thereof as the movement program for controlling the robot.

3. The method according to claim 1, wherein the measurement variables detected by the measurement system are transmitted in a protected manner, so as to prevent corruption of measured values.

4. The method according to claim 1, comprising detecting individual positions of the handling appliance.

5. The method according to claim 1, comprising detecting the co-ordinate data of complete paths.

6. The method according to claim 1, wherein the teaching is carried out via two-handed control.

7. The method according to claim 6, wherein the co-ordinate data is detected in six dimensions.

8. The method according to claim 6, comprising utilizing the detected and evaluated co-ordinate data to convert the movement path to an exact movement program for path reproduction.

9. An industrial robot comprising:
a stand;
at least one moving jointed arm, the jointed arm having a free end comprising a detachable connection means for connecting and disconnecting an end effector to/from the free end of the jointed arm;
a measurement system having a measurement head arranged at the free end of the industrial robot, the measurement system being configured to automatically determine each respective position and orientation of the end effector and transmit data representative of the determined position and orientation of the end effector to a monitoring and control unit; and
a handling appliance configured to teach movement processes for the robot and for the jointed arm, and being configured to be guided manually.

10. The industrial robot according to claim 9, wherein the measurement system is arranged in a protected manner at the free end of the jointed arm.

11. The industrial robot according to claim 9, wherein the measurement system is accommodated in a rigid housing and is configured to communicate with the monitoring and control system via transmission lines which are arranged in a protected manner in the jointed arm of the robot.

12. The industrial robot according to claim 11, comprising a plug connection and a latch connection to secure the measurement system in the housing.

13. The industrial robot according to claim 11, comprising a force-fitting connection to secure the measurement system in the housing.

14. The industrial robot according to claim 11, comprising a spring system configured to provide a secure mechanism for the measurement system in the housing.

15. The industrial robot according to claim 13, comprising an actuating lever or pivoting lever to secure the measurement system in the housing.

16. The industrial robot according to claim 9, wherein the measurement system is configured to be removable from the free end of the jointed arm, independent of the end effector.

17. The industrial robot according to claim 10, wherein the measurement system is accommodated in a rigid housing and is configured to communicate with the monitoring and control system via transmission lines which are arranged in a protected manner in the jointed arm of the robot.

18. The industrial robot according to claim 10, wherein the measurement system is configured to be removable from the free end of the jointed arm, independent of the end effector.

19. The industrial robot according to claim 11, wherein the measurement system is configured to be removable from the free end of the jointed arm, independent of the end effector.

20. The industrial robot according to claim 9, wherein the measurement system is configured to be removable from the free end of the jointed arm while the end effector is maintained in position.
